(19) United States
(12) Patent Application Publication
(10) Pub. No.: US 2002/0040307 A1
(43) Pub. Date: Apr. 4, 2002

(54) Method and system for tracking, reconciling and administering fees and costs in investment-based variable life insurance value

(76) Inventors: Michael Roscoe, South Windsor, CT (US); Jerry Scheinfeldt, East Hartford, CT (US); James Hedreen, Madison, NJ (US); Jerry Schwartz, Fisher Island, FL (US)

Correspondence Address: Arthur L. Plevy, Esq., Duane, Morris & Heckscher LLP, Suite 100, 100 College Road West, Princeton, NJ, 08540, US

(21) Appl. No.: 09/891,978

(22) Filed: Jun. 26, 2001

Related U.S. Application Data
(60) Provisional application No. 60/214,076, filed on Jun. 26, 2000.

(51) Int. Cl. G06F 17/60

(52) U.S. Cl. 705/4

(57) ABSTRACT

A method for determining a life insurance policy value by tracking and reconciling a policy's value in units that have a normalized value is disclosed. In accordance with the principles of the invention, a normalize unit value is determined at the conclusion of each of a predetermined period from a preceding net unit value and an investment instrument performance return achieved during each period. No fees associated with performance or management are deducted from the policy value principle or investment gain during each predetermined period. Rather, when an investment performance return is positive, a known percentage of the positive investment return is determined and accumulated, i.e. carried forward, to a predetermined date. When the performance return is negative, the known percentage is set to zero. At the predetermined date, the policy value is reconciled by deducting the accumulated percentage of the positive return is represented in units, based on the current net unit value, from the insurance policy value. Accordingly, fees only accumulate when a positive return is determined and only deducted at a specified time.

### FIELD OF THE INVENTION

The present invention relates to accounting systems and more specifically to tracking, reconciling and administering costs associated with investments in variable life insurance policies.

### BACKGROUND OF THE INVENTION

Insurance and insurance policies are well-known aspects of a modern society. Insurance policies are issued, as is known, for a host of different situations for which a single catastrophe could financially ruin a person, family or corporation. Insurance policies typically are issued to cover costs related to a damage to a policyholder's property or to another's property. Life insurance policies are used to provide a monetary benefit upon the demise of the insured party.

Insurance policies are used also as investment vehicles because of certain tax favored treatment; a cash value buildup accumulates tax-deferred, withdrawals are not taxable, death proceeds are free from income tax and under certain conditions, death proceeds paid to a trust are free from federal estate taxes. In one type of investment insurance policy, a policy holder can contract with an insurance company to make a single payment, for example, which then can be used to provide at a future time an income stream for a fixed number of years or a death benefit. Such investment insurance policies may provide a fixed or variable income stream to the policyholder, in accordance with the insurance contractual terms.

To cover the future cost to the insurance company in providing an income stream to the policyholder, the premium paid by the policyholder, after fixed obligations, e.g., taxes, investment fees and costs are deducted and invested in instruments that provide a positive return on the investment. For example, the policy holder's contracted premium is invested, as an aggregate with other policyholder's premiums, in stocks, government bonds, corporate bonds, mutual funds, etc. The positive or negative gain on the investment must be tracked and reconciled for each policyholder for each investment vehicle the premium is invested. FIG. 1 illustrates an exemplary process 100 for determining an insurance policy value. In this case, the policyholder premium 110 is reduced by state taxes 115, a Federal Deferred Acquisition Tax (DAC) 120 and a sales load factor 125. State taxes depend upon the specific location and ranges between two and three percent of the premium value, while current Deferred Acquisition Tax (DAC) 120 is approximately 1.75 percent of the premium value. The reduced premium value 127 is then added to fund value 150 by converting reduced premium 127 to a known number of units based on a current unit or share price. Unit accounting provides for a consistent valuation of the policy over the long-term life of the policy.

Gains or losses in investment value of the accumulated premiums are also added to fund value 150. In this illustrated example, a net investment performance 135 is determined by an investment accounting system 130. Investment accounting system 130 determines net investment performance based on a “gross dollar” basis for each individual investor. Investment accounting system 130 typically tracks the performance of one or more investment vehicles to which the policyholder's premiums are invested and provides a net investment value for each investment vehicle. In this exemplary case, a single investment vehicle is illustrated. However, it will be appreciated by those skilled in the art that the accounting system 130 is also applicable to more than one investment vehicle.

Net Investment Performance 135 is then reduced by an insurance company Mortality and Expense Charges (M&E) 140, which is well known in the art, and the reduced net investment performance value 142 is added to fund value 150. Net performance value 142 is also converted to a number of units based on the current unit price.

Fund value 150 is next reduced by insurance company fees, such as cost of insurance (COI) 155 and administration costs 160 and a cash surrender charge 175. Fund value 150 reduced by the COI and cash surrender charge 175 results in a value of the policy to the policyholder, i.e., policy value 180. To pay the noted fees, the fees are converted to an equivalent number of units at the current unit price and the corresponding number of units is removed from fund value 150. The current unit price is conventionally referred to as net asset value (NAV).

Typically, investment accounting system 130 is operated by the management of the investment vehicle into which the premiums have been placed. The premium investment generally is performed at known periods of time, e.g., daily, monthly, quarterly, yearly, etc. Account system 130 reduces a gross performance value 132, e.g., dollar increase in the value, of each of the at least one investment vehicles the individual policyholder's premium has been invested, by an associated management or administration fee 134, an associated expense fee 136, and an associated performance fee 138. Management or administration fee 134 typically is in the order of one percent of the gross positive increase in the investment value. Expense fee 136, which relates to fixed costs, such as accounting, legal expenses, overhead, etc., is typically 0.5 percent of gross positive increase in investment value and performance fee 138 is typically twenty percent of gross positive increase in investment value after expenses. If there is a negative gain in the performance of the fund, the performance fee 138 is typically zero. However, whether the fund achieves a positive or negative return, the management fee is deducted from the invested funds.

While accounting system 130 is applicable to yearly changes in investment gains or loses, it is not well suited for insurance accounting systems, which must consider a much longer term view of the investment and the influx of additional premiums. With the current mixing of investment and insurance accounting systems there are problems in determining the policy value when a yearly investment return is positive, however, long-term investment continues to support a negative investment return. For example, in a single year an investment may increase in value, which incurs management and performance fees, however, the aggregate value of the insurance policy may have a negative growth. Hence the value of the policy is further decreased by the deduction of management and performance fees, even though the policy value has been reduced. Thus, the accounting of the policy value can be adversely effected by the use of mixed accounting systems for management fees and insurance fees.

To qualify for the tax favorable treatment of an insurance policy, state and federal regulations require that the net asset value of each of the policies must be substantial the same. This can be difficult to maintain when the value of one policy has a decrease in value because of long-term losses while the value of a second policy has an increase in value because of short-term gains.

Hence, there is a need to provide a straightforward method of determining costs and fees associated with investment management of insurance contracts which considers the short and long term growth or decrease in the investment funds and treats each policy holder is the same manner.

### SUMMARY OF THE INVENTION

A method for administrating life insurance policy value by tracking and reconciling paid premiums and investment returns is disclosed. The method comprising the steps of storing investment data on each of at least one investment instrument for which a life insurance premium is invested, determining a first net asset value of each of unit at a first known period, determining a performance return of each of the at least one investment instruments at a second known period, determining a second net asset value at the second known period in relation to the first known period net asset value corresponding to said investment instrument and the investment instrument performance return, determining the first net asset value at the second known period by deducing at least one expense from the second net asset value, determining a performance fee as a known percentage of a change in value of each investment instrument when the a corresponding investment return is positive; carrying each of said determined performance fees forward; and adjusting the policy value by a number of units corresponding to a change in each of said investment instrument value reduced by the corresponding performance fee determined using the first net asset value at a third known period.

### BRIEF DESCRIPTION OF THE DRAWINGS

In the drawings:

FIG. 1 illustrates a conventional system for fee allocation and obligations in investment managed insurance policies;

FIG. 2 illustrates an exemplary system for fee allocation and obligations in accordance with the principles of the present invention;

FIG. 3 illustrates an exemplary processing flow-chart for fee allocation in accordance with the principles of the present invention;

FIG. 4 illustrates an exemplary processing flow-chart for determining a net asset value;

FIG. 5 depicts an exemplary investment instrument performance;

FIG. 6 depicts an insurance policy valuation using the exemplary investment performance depicted in FIG. 5;

FIG. 7 depicts an insurance policy valuation in accordance with the principles of the present invention using the exemplary investment performance depicted in FIG. 5;

FIG. 8 depicts a insurance policy valuation of a second insurance policy using the investment performance depicted in FIG. 5 in accordance with a conventional accounting method; and

FIG. 9 depicts an insurance policy valuation of a second insurance policy in accordance with the principles of the present invention using the investment performance depicted in FIGS. 5.

It is to be understood that these drawings are solely for purposes of illustrating the concepts of the invention and are not intended as a definition of the limits of the invention. It will be appreciated that the same reference numerals, possibly supplemented with reference characters where appropriate, have been used throughout to identify corresponding parts.

### DETAILED DESCRIPTION OF THE INVENTION

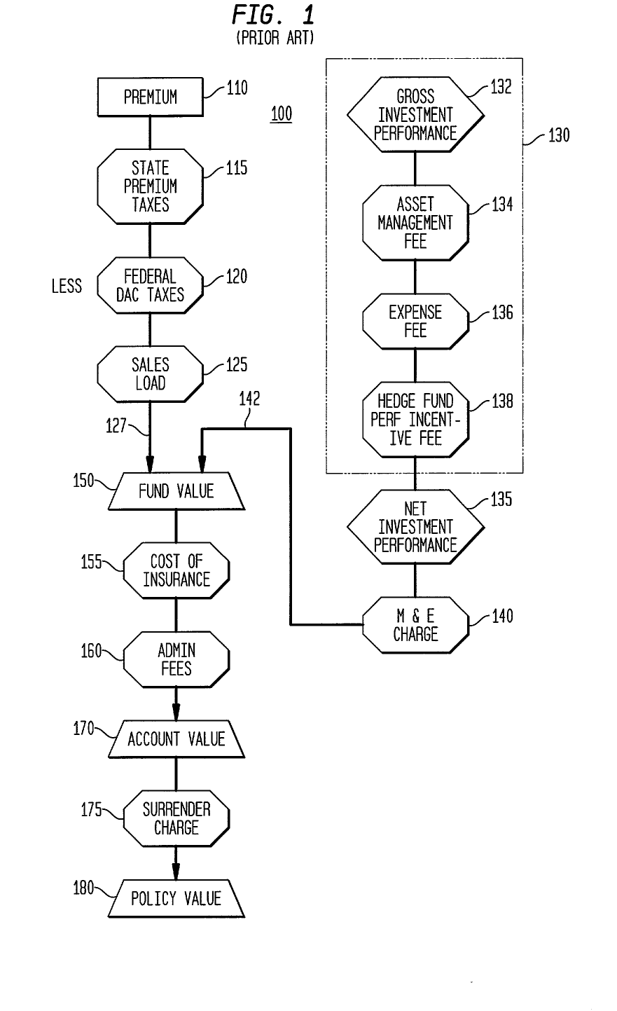

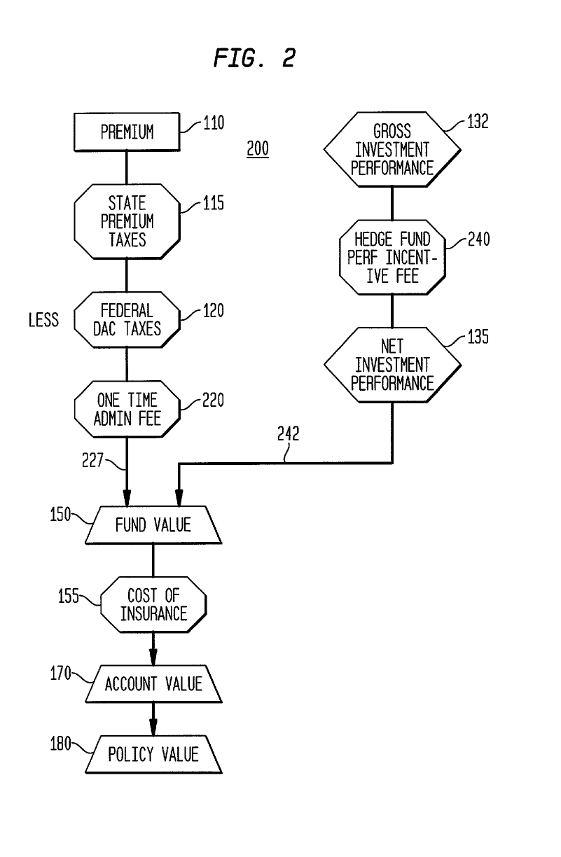

Referring now to FIG. 2, there is shown an exemplary system 200 for cost and fee allocation in accordance with the principles of the present invention. In this exemplary system 200, premium 110 is subjected to costs and fees in a manner similar to that shown in FIG. 1. That is, premium 110 is reduced by state and federal obligations 115 and 120, respectively, and sales load, which in this case is a one-time fee 220. Gross investment performance 132,however, is reduced by performance incentive fee 240 and is stored as the net investment performance 135. Performance incentive fee 240, as will be more fully described, is representative of investment management fees and costs adjusted for unit based pricing or NAV.

In the processing of system 200 obligation-reduced premium 227 and the net investment performance 242 is added to the fund value 150. Fund value 150 is then reduced by a cost of insurance 155, which is then representative of account value 170 and policy value 180.

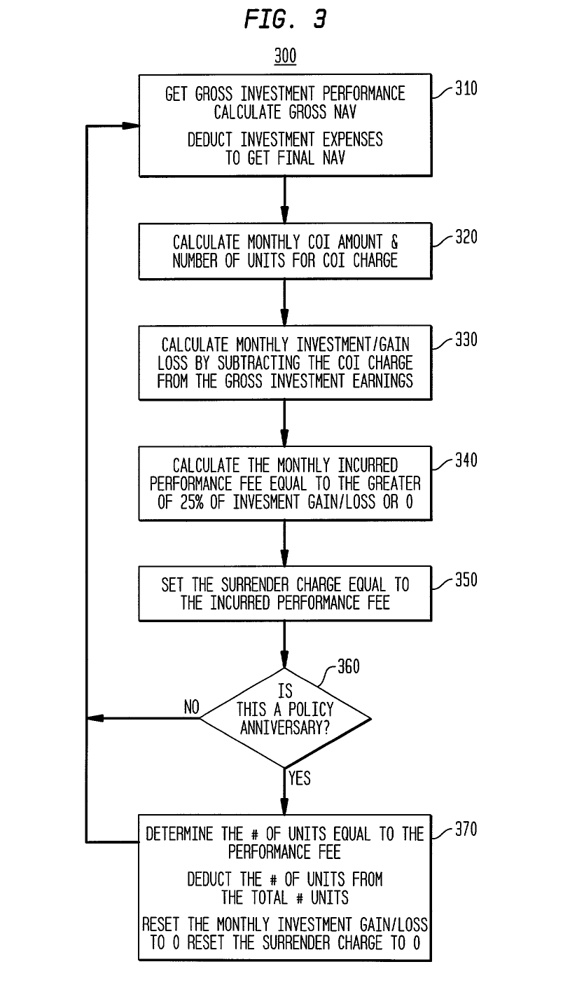

FIG. 3 illustrates a flow chart of an exemplary processing 300 for determining performance incentive fee 240 for each investment instrument the policyholder's aggregated premiums 110 are invested in. In this illustrated example, and preferred embodiment, performance incentive fee 240 is determined on a monthly basis. However, it will be appreciated that performance incentive fee 240 may also be determined on a daily, weekly, quarterly or yearly basis. At block 310, the gross investment performance and gross net asset value (NAV) for a particular investment instrument is obtained. Further, a final NAV value is determined by deducting expenses from the determined gross (NAV). At block 320 a cost of insurance (COI) amount is determined for the associated policyholder and a corresponding number of units is determined. At block 330 an investment gain or loss is determined by deducting the number of units corresponding to the COI amount from the number of units corresponding to the gross investment performance. At block 340, an incurred performance fee is determined as a known percentage of a positive gross investment gain. In a preferred embodiment, incurred performance fee is twenty-five percent of the gross investment performance. However, if the gross investment performance is negative, then the incurred performance fee is fixed at a known value. In a preferred embodiment, the incurred performance fee for a negative gross investment performance is set to zero. At block 350, a cash surrender charge is next set substantially equal to the incurred performance fee.

At block 360 a determination is made whether a policy anniversary date. If the answer is in the negative, then process continues at block 310 for the next investment instrument to which the policyholder's premium has been applied.

If, however, the answer is in the affirmative, then the incurred performance fee is converted into a number of units at the current policy unit price, at block 370. The number of performance fee units is then deducted from the number of units associated with the gross investment performance to arrive at a net investment performance for the associated investment instrument.

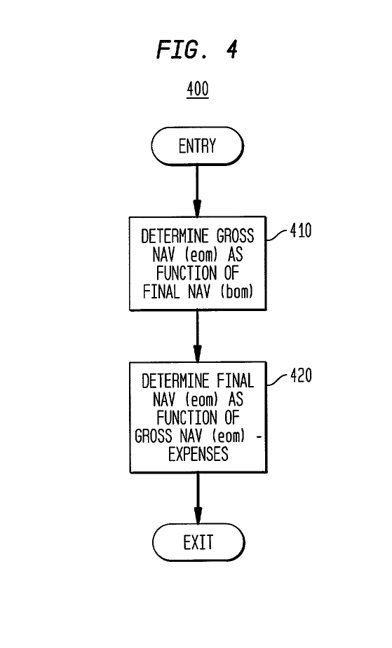

FIG. 4 illustrates a flow chart of an exemplary process 400 for determining final net asset value in accordance with the principles of the present invention. In this exemplary process, at block 410, a gross NAV at the end of a month (eom) is determined from a preceding final NAV determined at the beginning of the month (bom). For example, gross NAV may be determined as a function of a prior final NAV as:

$${Nav}_{g} = {Nav}_{f} ( \frac{IP}{12} )$$

Where Nav_{g} is the gross NAV at the end of the month

Nav_{f} is the final NAV at the beginning of the month

IP is the annualized investment performance return for the month.

At block 420, a final NAV at the end of the month is then determined from the gross NAV by deducting investment expenses appropriately. Investment expenses can include fund administration expenses and manager fees.

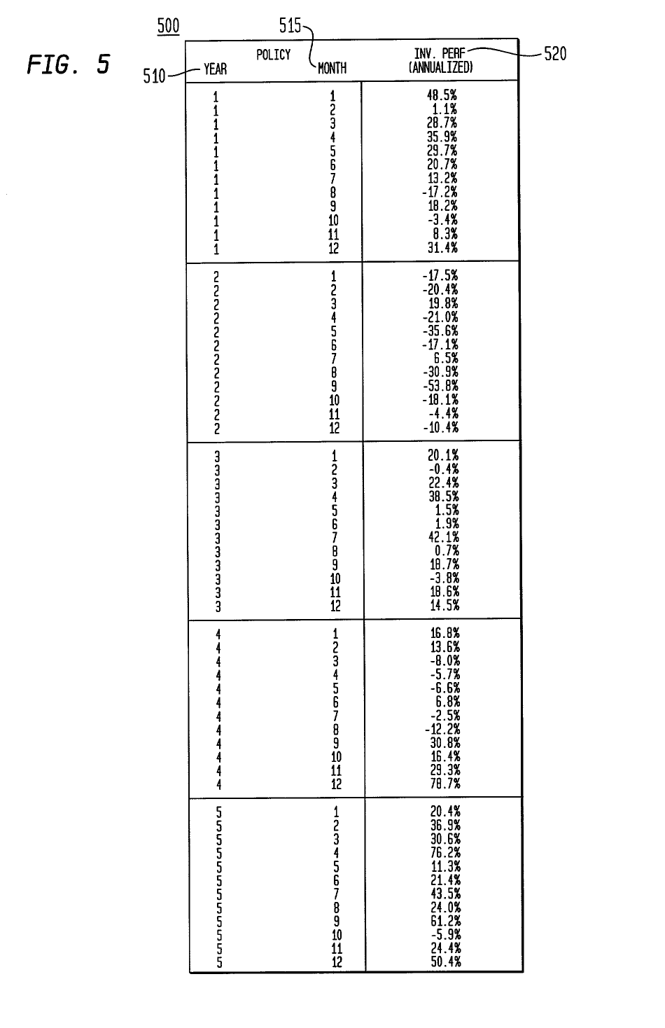

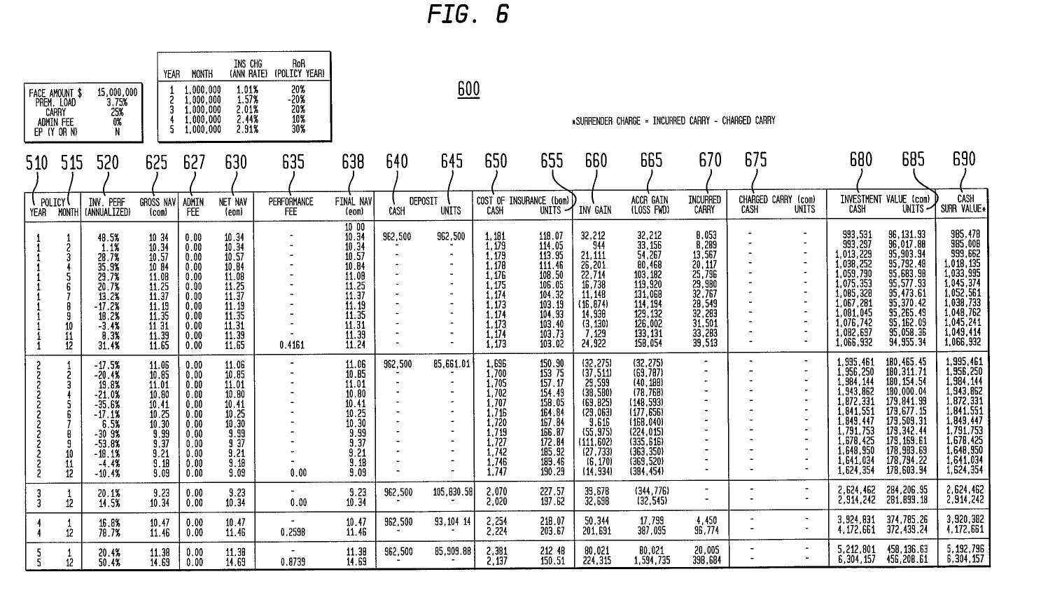

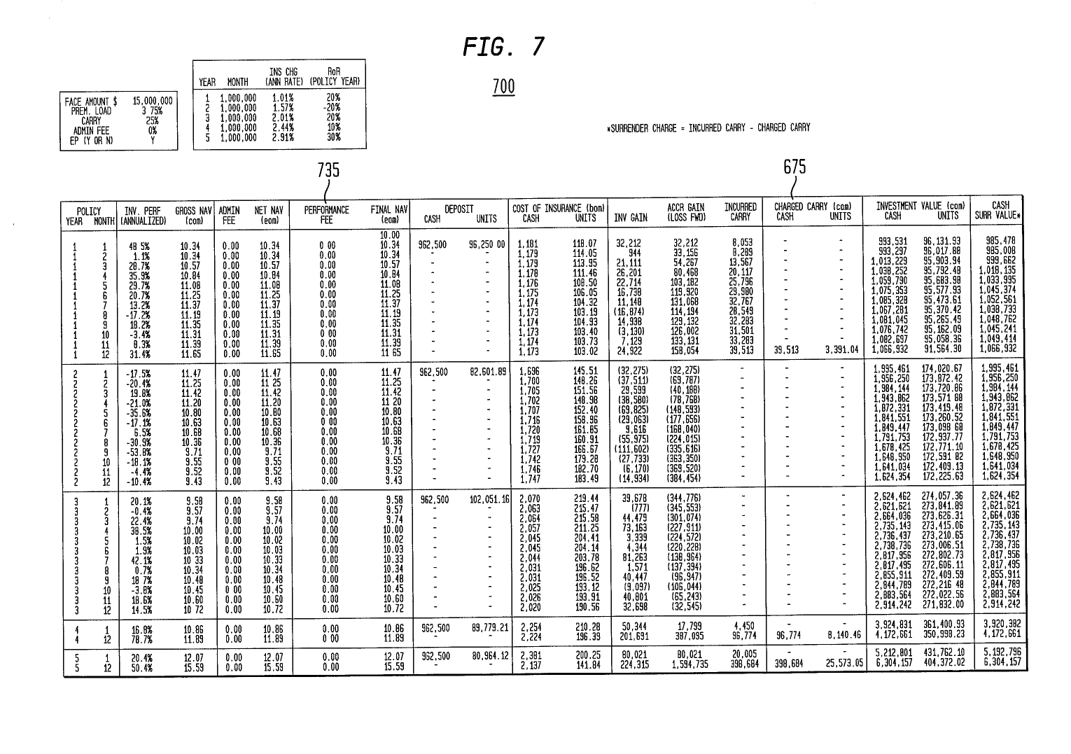

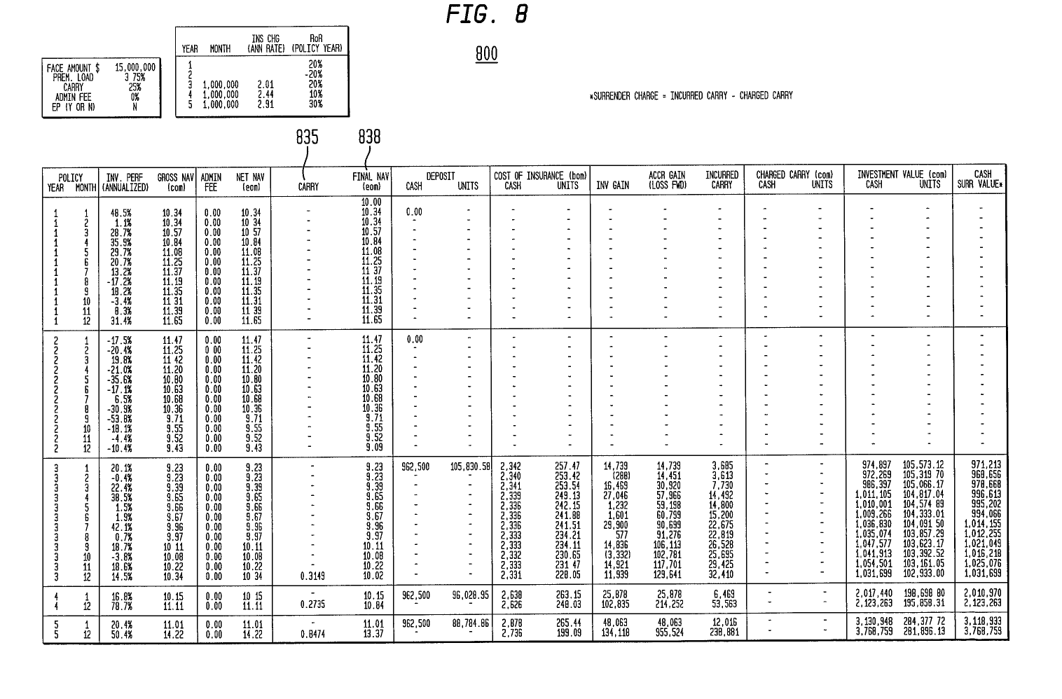

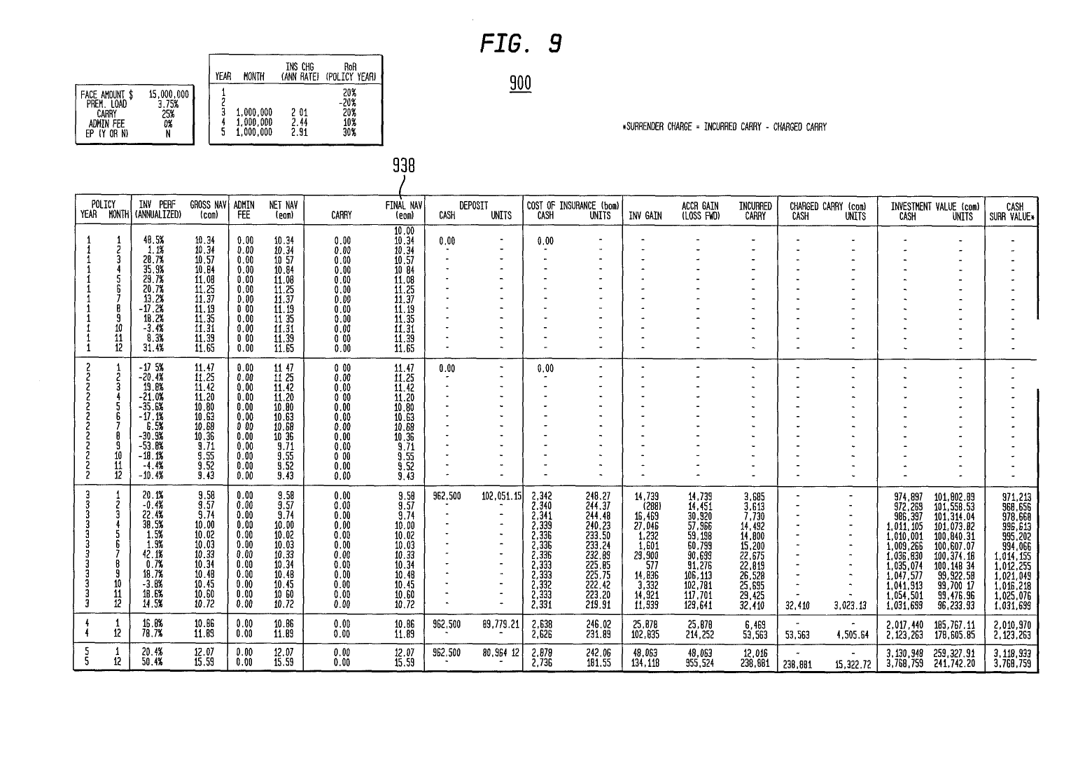

An example of tracking and reconciling of a policy value in accordance with the principles of the present invention is illustrated with the following example shown collectively in FIGS. 5 through 9. FIG. 5 is representative of the performance return of an investment instrument, such as a hedge fund, stock, bond, mutual fund. It will be appreciated each investment instrument will have an independently determined investment performance return profile. For the illustrated example herein, a single investment vehicle is illustrated. However, it will be appreciated, that a plurality of investment vehicles or instruments may be utilized to improve the overall return on investment. FIG. 6 is representative of a variable life insurance policy invested in a investment instrument or vehicle in accordance with current accounting methods. FIG. 7 is representative of a variable life insurance policy invested in an investment instrument in accordance with the principles of the present invention. FIG. 8 is representative of a second variable life insurance policy invested in the investment instrument after a fixed period in accordance with current accounting methods. FIG. 9 is representative of a second variable life insurance policy invested in an investment instrument after a fixed period in accordance with the principles of the present invention.

Referring now to FIG. 5, there is shown an exemplary annualized performance of an investment instrument for each month over a five-year period. In this example, years are depicted in column 510, months within a corresponding year are depicted in column 515 and annualized performance for corresponding months is depicted in column 520. The performance return values illustrated are randomly selected to illustrate the investment growth performance considering both positive and negative performance of the investment instrument.

FIG. 6 illustrates the investment performance 600 over a five-year period for an insurance policy having a premium payment of $ 1,000,000 for each of the first five years of the life of the policy using a conventional accounting system. In this illustrative example and those shown in FIGS. 7-9, the net asset value (NAV) of each unit is initially selected as a final NAV of 10.00 per unit, as shown as the first entry in column 638. In this example, each unit is representative of a United States dollar amount, however, it will be understood by those skilled in the art that the shares may represent alternative valuations, such a tens of USD, German Marks, British Pounds, Japanese Yens, etc. The initial insurance premium of $ 1,000,000 USD, after obligations are deducted, is reduced to a net cash deposit of $ 962,500.00 USD, as shown as the first entry in column 640. Accordingly, in this example, the policy value has a valuation of 96,250 units as shown as the first entry in column 645.

The valuation of the insurance policy will now be discussed in detail with reference to the first year that the initial premium is invested in the investment instrument. In this example, there is a change in the gross, the net and final NAV, is shown in columns, 625, 630 and 638, respectively. To provide a simplified view of the calculations, the investment instrument administration fees, as shown in column 627, are set to zero. It will be appreciated that administration fees are typically not equal to zero when there is a positive return, however, the inclusion of a non-zero administration fee only services to increase the complexity of illustrating the novel features of the present invention, so this value has been set equal to zero.

Also shown are the cost of insurance and a corresponding number of units, which are deducted for each month of the first year of investment. The investment value in dollars and units is shown in columns 680 and 685 respectively.

In accordance with current accounting practice, at the conclusion of the first year a performance fee is deducted from the investment based on the gain of the investment instrument. This is shown as the first non-zero entry in column 635. In this case, the deduction of a performance fee reduces the resultant final NAV for the first year of investment from 11.65 per unit to 11.24 per unit. The value of the insurance policy and a corresponding number of units are shown in 680 and 685, respectively.

The valuation of the insurance policy is also shown in detail for the second year of investment. During the second year, a second premium payment, i.e., $ 962, 500.00, is deposited and at the current final NAV, 11.24 per unit, corresponds to 85,661.01 units, as shown in column 645. As with the first year, the monthly investment performance, the gross, net and final NAV, the cost of insurance and corresponding units and the investment valuation and corresponding number of units is shown in columns 520, 625, 630, 638, 650, 655, 680 and 685, respectively.

In this illustrative example, at the conclusion of the second year because there is a negative return on the investment, the performance fee is set equal to zero. In this case, the final NAV of 9.09 per unit is substantially the same as the net NAV of 9.09 per unit, as shown in columns 630 and 638, respectively.

As will be understood, the determination of the investment values proceeds in a similar manner for each month of the illustrated third, fourth and fifth years. Hence only the information items regarding investment values for the first and last months need be shown to illustrate the novel feature of the present invention. Thus, at the conclusion of the third, fourth and fifth years, the NAV is 10.34, 11.20 and 13.82 per unit, respectively.

FIG. 7 illustrates a similar analysis of investment instrument gain in accordance with the principles of the present invention. As will be appreciated, the determination of the illustrated values is similar to that previously discussed with regard to FIG. 6. However, in the present invention the performance fee charge is set equal to zero, as shown in column 735 and is represented as a carry over with a corresponding number of units, as shown in column 675. Hence, the final NAV and the net NAV remain substantially the same. In this case, the final NAV is 11.65, 9.43, 10.72, 10.86 and 15.59 per unit, at the conclusion of first through fifth years, respectively. It will be appreciated that the investment valuation at the end of the fifth year is the same value whether a conventional method or the method of the present invention is utilized.

The advantage of the present invention over conventional methods of tracking, and reconciling investment growth and insurance valuation is now shown with regard to FIGS. 8 and 9 in conjunction with FIGS. 6 and 7. FIG. 8 illustrates the investment growth of a second policyholder that begins investing in the third year of the investment program. In this case, the premium of the second policyholder, which is similar to that shown in FIGS. 6 and 7 is valued using an initial NAV of 9.09 per unit, i.e., final NAV at the conclusion of the second year. With the same gains in investment performance, which are subjected to performance fees, 0.3149, 0.2735 and 0.8474, in years 3, 4 and 5, respectively, as shown in column 835, the final NAV at the conclusion of the fifth year is determined as 13.37 per unit, as shown in column 838. In comparison, the final NAV of the first policyholder, at the conclusion of the fifth year is 13.82 per unit, as is shown in column 638 of FIG. 6. Hence, in accordance with conventional accounting method, NAV of respective policyholders is different depending upon the policyholder's entry into the program and the performance return of the investment instrument.

FIG. 9 depicts, similar to FIG. 8, the entry of a second policyholder at the conclusion of the second year of the program using the method of the present invention. In this case, the premium of the second policyholder is valued at a final NAV of 9.43 per unit as shown in column 938. Furthermore, independent of the investment instrument performance gains over the illustrated third, fourth and fifth years, the final NAV for each of these years, as shown in column 938, is substantially similar to a corresponding final NAV of the first policyholder, as shown in column 738 of FIG. 7. Accordingly, the method of tracking and reconciling insurance policy value in accordance with the principles of the present invention provides a normalized reference of NAV for determining unit value. This is advantageous as it provides a single accounting method for tracking and reconciling a plurality of insurance policies that are invested in the same investment instruments rather than an essentially separate accounting system for each of a plurality of insurance policies in order to account for different investment beginning periods.

While there has been shown, described, and pointed out, fundamental novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention. For example, it is expressly intended that all combinations of those elements and/or method steps which perform substantially the same function in substantially the same way to achieve the same results are within the scope of the invention. Substitutions of elements from one described embodiment to another are also fully intended and contemplated.

We Claim:

1. A method for administrating life insurance policy value expressed in a plurality of units, said method comprising the steps of:
storing investment data on each of at least one investment instrument for which a life insurance premium is invested;
determining a first net asset value of each of said units at a first known period;
determining a performance return of each of said at least one investment instruments at a second known period;
determining a second net asset value at said second known period in relation to said first known period net asset value corresponding to said investment instrument and said investment instrument performance return;
determining said first net asset value at said second known period for each of said units by deducing at least one expense from said second net asset value;
determining a performance fee as a known percentage of a change in value of each of said investment instruments when said investment performance return is positive;
carrying each of said determined performance fees forward; and
adjusting said policy value by a number of units corresponding to a change in each of said investment instrument value reduced by said corresponding performance fee determined using said first net asset value at a third known period.

2. The method as recited in claim 1 wherein said premium value invested is reduced by deducting known obligations from said premium value.

3. The method as recited in claim 1 wherein further comprising the steps of:
determining a cost of insurance at said second known; and
reducing said policy value by a number of units corresponding to said cost of insurance using said first net asset value.

4. The method as recited in claim 1 wherein said at least one expense is selected from the group comprising: administrative expenses, performance fee, management fee.

5. The method as recited in claim 1 wherein said first known period is at the beginning of a period selected from the group comprising: daily, weekly, monthly, quarterly, yearly.

6. The method as recited in claim 1 wherein said second known period is at the end of a period selected from the group comprising: daily, weekly, monthly, quarterly, yearly.

7. The method as recited in claim 1 wherein said third known period is at the end of a period selected from the group comprising: daily, weekly, monthly, quarterly, yearly.

8. The method as recited in claim 1 wherein said third known period corresponds to an anniversary of said policy.

9. The method as recited in claim 1 wherein said first first net asset value is known.

10. A method for tracking and reconciling a life insurance policy value, said method comprising the steps of:
generating a number of insurance units for a premium value based on a first net asset value;
determining a performance return for each of at least one investment instruments for which said premium is invested;
determining a gross net asset value as a function of a previous first net asset value and said performance return for each of said at least one investment instrument;
determining a second net asset value by deducting at least one expense from said gross asset value;
determining a performance fee for each of said investment instruments as a known percentage of a positive change in value of a corresponding investment instrument;
determining a number of insurance units corresponding to said change in value of each of said investment instruments reduced by a corresponding performance fee using said second net asset value; and
adjusting, at a selected date, said policy value by said determined number of units corresponding to said change in value of each of said investment instruments reduced by a corresponding performance fee.

11. The method as recited in claim 10 wherein further comprising the steps of:
determining a cost of insurance at said second known; and
reducing said policy value by a number of units corresponding to said cost of insurance using said second net asset value.

12. The method as recited in claim 10 wherein said at least one expense is selected from the group comprising: administrative expenses, performance fee, management fee.

13. The method as recited in claim 10 wherein said selected date corresponds to an anniversary of said policy.

14. The method as recited in claim 10 wherein said first first net asset value is known.

15. The method as recited in claim 10 wherein said premium value invested is reduced by deducting known obligations from said premium value.

16. A system for administrating life insurance policy value expressed in a plurality of units, said system comprising:
a memory for storing investment data on each of at least one investment instrument for which a life insurance premium is invested;
a processor operable to execute code for:
determining a first net asset value of each of said units at a first known period;
determining a performance return of each of said at least one investment instruments at a second known period;
determining a second net asset value at said second known period in relation to said first known period net asset value corresponding to said investment instrument and said investment instrument performance return;
determining said first net asset value at said second known period for each of said units by deducing at least one expense from said second net asset value;
determining a performance fee as a known percentage of a change in value of each of said investment instruments when said investment return is positive; and
carrying each of said determined performance fees forward; and
adjusting said policy value by a number of units corresponding to a change in each of said investment instrument value reduced by said corresponding performance fee determined using said first net asset value at a third known period.

17. The system as recited in claim 16 wherein said processor is operable to further execute code for:
deducting known obligations from said premium value.

18. The system as recited in claim 16 wherein said processor is operable to further execute code for:
determining a cost of insurance at said second known; and
reducing said policy value by a number of units corresponding to said cost of insurance using said first net asset value.

19. The system as recited in claim 16 wherein said at least one expense is selected from the group comprising: administrative expenses, performance fee, management fee.

20. The system as recited in claim 16 wherein said first known period is at the beginning of a period selected from the group comprising: daily, weekly, monthly, quarterly, yearly.

21. The system as recited in claim 16 wherein said second known period is at the end of a period selected from the group comprising: daily, weekly, monthly, quarterly, yearly.

22. The system as recited in claim 16 wherein said third known period is at the end of a period selected from the group comprising: daily, weekly, monthly, quarterly, yearly.

23. The system as recited in claim 16 wherein said third known period corresponds to an anniversary of said policy.

24. The system as recited in claim 16 wherein said first first net asset value is known.

25. A system operable on at least one processing unit for tracking and reconciling a life insurance policy value including code operable for:
generating a number of insurance units for a premium value based on a first net asset value;
determining a performance return for each of at least one investment instruments for which said premium is invested;
determining a gross net asset value as a function of a previous first net asset value and said performance return for each of said at least one investment instrument;
determining a second net asset value by deducting at least one expense from said gross asset value;
determining a performance fee for each of said investment instruments as a known percentage of a positive change in value of a corresponding investment instrument;
determining a number of insurance units corresponding to said change in value of each of said investment instruments reduced by a corresponding performance fee using said second net asset value; and
adjusting, at a selected date, said policy value by said determined number of units corresponding to said change in value of each of said investment instruments reduced by a corresponding performance fee.

26. The system as recited in claim 25 wherein further operable for:
determining a cost of insurance at said second known; and
reducing said policy value by a number of units corresponding to said cost of insurance using said second net asset value.

27. The system as recited in claim 25 wherein said at least one expense is selected from the group comprising: administrative expenses, performance fee, management fee.

28. The system as recited in claim 25 wherein said selected date corresponds to an anniversary of said policy.

29. The system as recited in claim 25 wherein said first first net asset value is known.

30. The system as recited in claim 15 wherein said premium value invested is reduced by deducting known obligations from said premium value.

31. A improved method of determining life insurance policy value represented as a plurality of current insurance units having a premium deducted by state and federal tax objections invested in at least one investment instrument, which is subjected to at least one investment instrument fee including a management fee, an expense fee, and an incentive fee, said improvement comprising:
eliminating said investment instrument fee;
determining a net asset at a known period based on a performance return of each of said investment instruments; and
adjusting, at a selected date, said current number of said insurance units by a number of insurance units corresponding to a change in value of each of said investment instruments reduced by a corresponding performance fee, based on said net asset value, wherein said performance fee is a known percentage of said change in value of each of said investment instruments if said change in investment value is positive.

32. The method as recited in claim 31 wherein said performance fee includes a fee for investment management and performance.

33. The method as recited in claim 31 wherein said selected date corresponds to an anniversary of said policy.
